(19) United States
(12) Patent Application Publication
(10) Pub. No.: US 2014/0033089 A1
(43) Pub. Date: Jan. 30, 2014

(54) INTEGRATION OF TRANSACTIONAL ACTIONS INTO ANALYTICAL REPORTS

(71) Applicants: Karl-Peter Nos, Nussloch (DE); Stefan Girsig, Heidelberg (DE); Nadine Sachs, Wiesloch (DE); Michael Bundschuh, Neidenstein (DE); Sonja Barnet, Viernheim (DE); Torsten Bachmann, St. Leon-Rot (DE); Dirk Baumgaertel, Hockenheim (DE)

(72) Inventors: Karl-Peter Nos, Nussloch (DE); Stefan Girsig, Heidelberg (DE); Nadine Sachs, Wiesloch (DE); Michael Bundschuh, Neidenstein (DE); Sonja Barnet, Viernheim (DE); Torsten Bachmann, St. Leon-Rot (DE); Dirk Baumgaertel, Hockenheim (DE)

(73) Assignee: SAP AG, Walldorf (DE)

(21) Appl. No.: 13/558,268

(22) Filed: Jul. 25, 2012

(51) Int. Cl. G06F 3/048

(52) U.S. Cl. 715/764

(57) ABSTRACT

During an online analytical processing session, actions can be presented for performance on transactional data underlying the session. Actions can be filtered to those valid for a particular context. Other features, such as acquisition of parameters for the actions can be supported.

### BACKGROUND

As enterprises accumulate ever greater amounts of data on their transactions, processes, products, and operations, online analytical processing has become an essential part of doing business. The number of tools and techniques addressing analytical processing has grown, enabling data analysts to navigate through complex collections of data arranged in various ways, such as star schemas, data cubes, and the like.

Due to legacy reasons, the online analytical processing is traditionally performed on data that is separate from live transactional data. Accordingly, although current online analytical processing tools provide a wide variety of functionality, they leave operations on the transactional data to other tools. There is therefore room for improvement.

### SUMMARY

The Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

Transactional actions can be integrated into analytical reports. During an online analytical processing session, actions can be performed on transactional data underlying the session. Possible actions can be filtered to those that are valid for activation by a user.

Additional features, such as acquiring parameters for the actions, performing actions via business objects, and the like can be supported.

As described herein, a variety of other features and advantages can be incorporated into the technologies as desired.

### BRIEF DESCRIPTION OF THE DRAWINGS

FIG. 1 is a block diagram of an exemplary system implementing integration of transactional actions into analytical reports.

FIG. 2 is a flowchart of an exemplary method of integrating transactional actions into analytical reports.

FIG. 3 is a block diagram of an exemplary system implementing transactional actions in a client/server arrangement.

FIG. 4 is a screen shot of an exemplary user interface implementing integration of transactional actions into analytical reports.

FIG. 5 is a flowchart of an exemplary method implementing integration of transactional actions into analytical reports at a server.

FIG. 6 is a flowchart of an exemplary method implementing integration of transactional actions into analytical reports at a client.

FIG. 7 is a block diagram showing exemplary action filtering.

FIG. 8 is a screen shot of an exemplary user interface implementing acquisition of parameters for a transactional action.

FIG. 9 is a flowchart of an exemplary method implementing acquisition of parameters for a transactional action at a server.

FIG. 10 is a flowchart of an exemplary method implementing acquisition of parameters for a transactional action at a client.

FIG. 11 is a block diagram of an exemplary business object.

FIG. 12 is a diagram of an exemplary computing system in which some described embodiments can be implemented.

### DETAILED DESCRIPTION

### Example 1

### Exemplary Overview

The technologies described herein can be used for integrating transactional actions into analytical reports in a variety of scenarios. Adoption of the technologies can provide efficient techniques for performing actions on data (e.g., discovered via an analytical report).

The technologies can be helpful for those wishing to explore data using online analytical processing and then perform actions on the underlying data directly from an analytical report. The gap between analytical reporting and transactional tasks can be avoided. Beneficiaries include analytical report users who wish to find data on which actions are to be performed and then perform the actions using a familiar analytical user interface. Internal and external developers can also indirectly benefit from the technologies because they can be relieved of having to develop additional software to allow users to perform actions.

### Example 2

### Exemplary System Implementing Integration of Transactional Actions into Analytical Reports

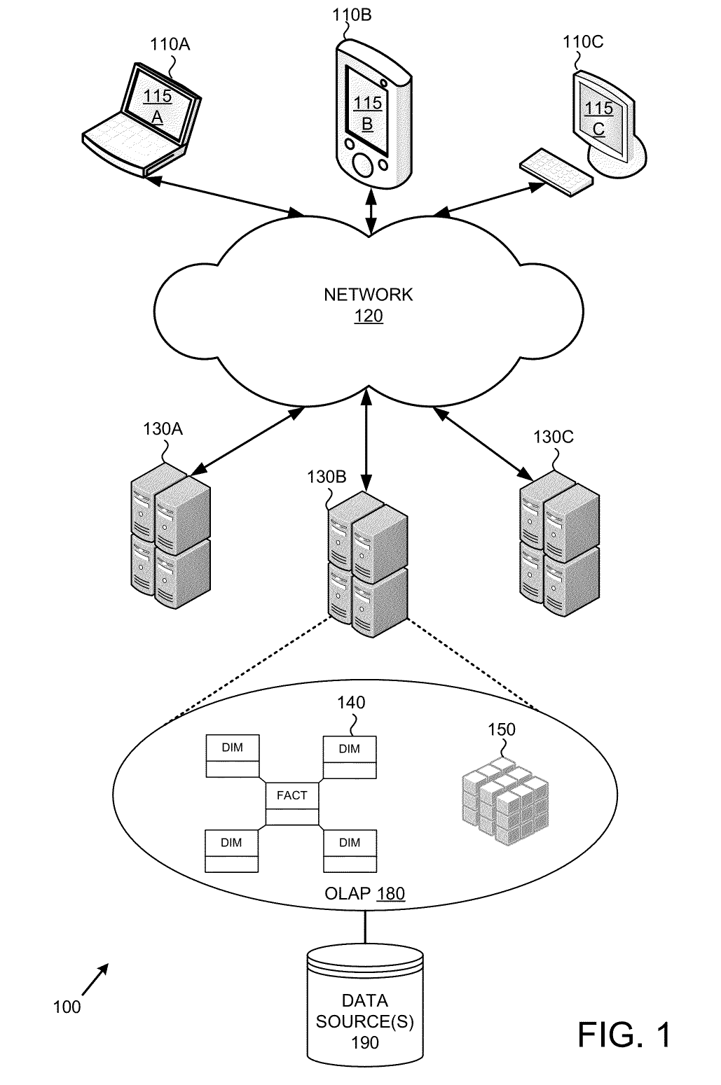

FIG. 1 is a block diagram of an exemplary system 100 implementing integration of transactional actions into analytical reports described herein.

In the example, any number of client devices 110A-C present user interfaces 115A-C by which the devices 110A-C can interact with server devices 130A-C via a network 120 to perform the described technologies.

A server 130B can offer access to data sources 190 via online analytical processing (OLAP) functionality 180, which can include presentation or representation of the data sources 190 as being organized according to a star schema 140, a data cube 150, or the like.

In practice, online analytical processing functionality can be invoked by activating an analytical report template, which begins an online analytical processing session by which the client devices 110A-C can navigate through the data.

In practice, the systems shown herein, such as system 100 can vary in complexity, with additional functionality, more complex components, and the like.

The system 100 and any of the other systems described herein can be implemented in conjunction with any of the hardware components described herein, such as the computing systems described below (e.g., processing units, memory, and the like). In any of the examples herein, the inputs, outputs, and tools can be stored in one or more computer-readable storage media or computer-readable storage devices. The technologies described herein can be generic to the specifics of operating systems or hardware and can be applied in any variety of environments to take advantage of the described features.

Client/server operation can be supported, and cloud computing techniques can be applied to give clients the ability to perform the described techniques without concern over the actual computing infrastructure needed or used to operate the servers, which can be administered by a business entity different from the client user.

### Example 3

### Exemplary Method Implementing Integration of Transactional Actions into Analytical Reports

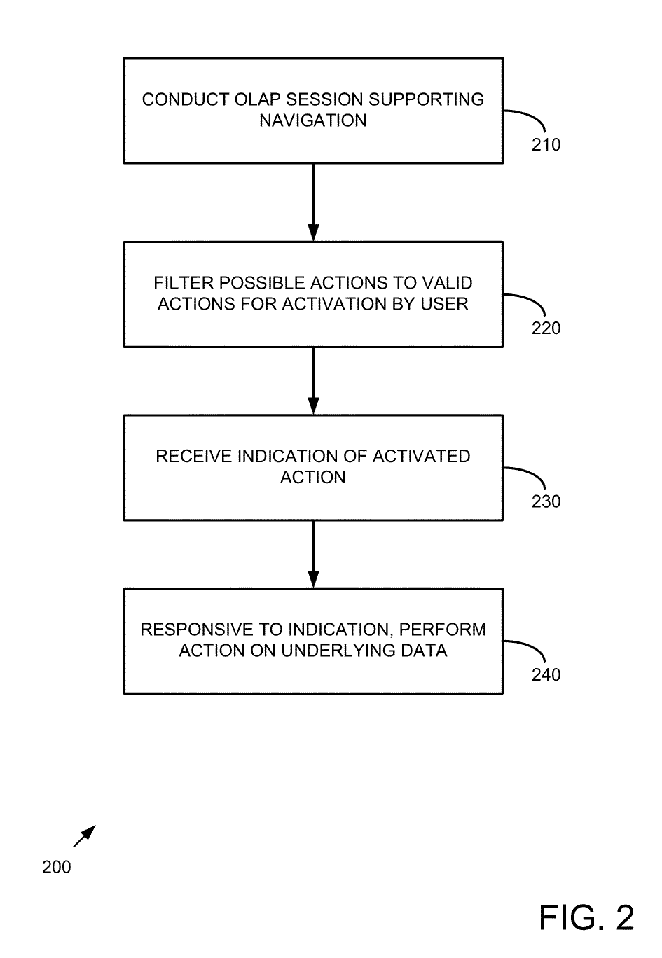

FIG. 2 is a flowchart of an exemplary method 200 of integrating transactional actions into analytical reports and can be implemented, for example, in the system shown in FIG. 1 during an online analytical processing session.

At 210, an online analytical report supporting navigation is conducted. As described herein, an online analytical processing session can be based on a report template, which has associated metadata that can be used to support the technologies described herein. Such a session typically comprises displaying data in various fields of the report, and a user can navigate within the report using online analytical processing techniques.

During the session, an indication to navigate within the displayed data can be received, and successive presentations of data (e.g., different views of the data) can be presented (e.g., as rows, cells, or the like).

At 220, possible actions are filtered to one or more valid actions for activation by a user. As described herein, possible actions can be filtered according to metadata (e.g., report metadata that indicates which actions supported by a business object are designated as permissible to be performed), context, and the like. The valid actions are typically presented to a user as corresponding user interface elements (e.g., presenting a name or icon of the respective action) that can be activated by a user.

At 230, an indication of an activated action is received during the online analytical processing session. For example, when a user activates a user interface element, the activation (e.g., and an indication of which action was activated) is communicated to the analytical report tool.

At 240, responsive to the indication that the action was activated, the action is performed on the data underlying the online analytical processing session (e.g., the transactional data). The action can thus be performed during the online analytical processing session (e.g., at the direction of the analytical report tool).

After performing the activated action, the online analytical processing session (e.g., data displayed by the report) can be updated to reflect that the activated action has been performed.

The method 200 and any of the other methods described herein can be performed by computer-executable instructions (e.g., causing a computing system to perform the method) stored in one or more computer-readable media (e.g., storage or other tangible media) or stored in one or more computer-readable storage devices.

### Example 4

### Exemplary Selection of Data During Session

In any of the examples herein, during an OLAP session, data can be selected (e.g., by selecting one or more user interface elements such as rows, cells, or the like). Such selection can alter context (e.g., based on the one or more fields selected, the type of data selected, and the like) and also indicate the data (e.g., one or more fields) on which the activated action is to be performed. Thus, filtering can be based on a selection of a subset of the data of the OLAP session. The (x,y) coordinates (e.g., using −1 to indicate an entire row is selected) of such selection can be translated into an indication of which data has been selected, along with the type of data (e.g., a field in the report). In implementations using business objects, the coordinates can indicate which instances of the business objects are involved.

Thus, an indication of a selection of a subset of the data displayed during an OLAP session can be received, and performing the activated action comprises performing the action on the subset of data.

For example, if a customer is selected, the context can so indicate so that only actions performable on a customer are shown. Subsequently, when the action is activated, the action can be performed on the selected customer. Selection of multiple data items can be supported.

### Example 5

### Exemplary Aggregation

In any of the examples herein, a single row or cell in a report can represent many business objects. For example, aggregation can combine plural business objects into a single line or cell. It may be desirable to inhibit actions in such instances because the user is not aware of which entities (e.g., customers, vendors, or the like) are involved. However, actions on aggregated actions can be supported by determining the instances involved and iterating the actions against the business objects associated with the aggregated row or aggregated cell. Aggregation can be controlled during analytical report design by specifying whether actions are valid on aggregated data as part of the report configuration. During presentation of the user interface, it can then be determined whether aggregation is enabled or not for a given row or cell.

### Example 6

### Exemplary Transactional Actions in Client/Server Arrangement

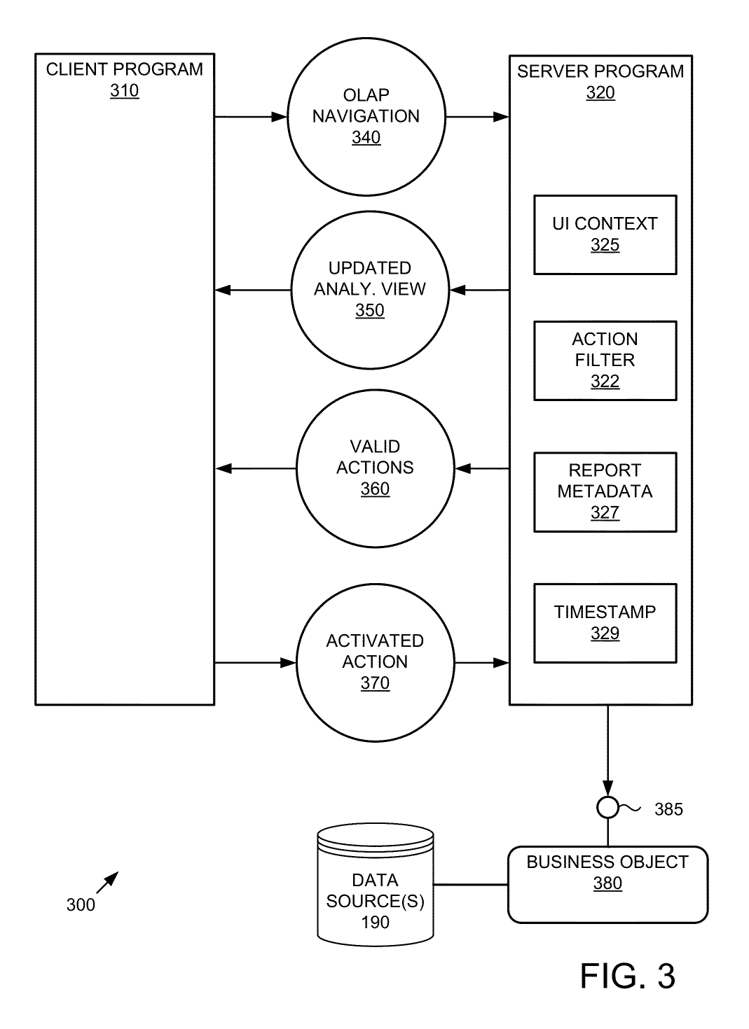

FIG. 3 is a block diagram of an exemplary system 300 implementing transactional actions in a client/server arrangement. In the example, a client program 310 is in communication with a server program 320 (e.g., an analytical report tool) that accesses one or more data sources 190. Access can be achieved via a business object 380 that provides an interface 385 by which actions can be initiated for processing by the business object 380.

Supporting a client/server arrangement can be particularly helpful in implementing the technologies in a software as a service (SaaS) and cloud computing scenarios. To promote wide availability, the client can take the form of any of a wide variety of computing devices supporting commonly available protocols and formats (e.g., HTTP, HTML, and the like).

In the example, the server program 320 includes state information such as user interface (UI) context 325, report metadata 327, and a timestamp 329. An action filter 322 can also be implemented to filter actions according to the context 325 (e.g., which indicates which fields of the report are selected, which fields are displayed, or the like) and the report metadata 327 (e.g., which indicates which actions are to be presented when a given field is selected or displayed).

The timestamp 329 can indicate a time when the displayed report was current (e.g., a time when the data was retrieved from the data sources).

In the example, information 340 regarding navigation within the OLAP session is sent from the client program 310 to the server program 320. In response, information 350 for an updated analytical view is sent from the server to the client (e.g., reflecting the navigation desired by the user). Along with the view information 350, indicates 360 of valid actions (e.g., actions performable on data associated with selected fields) as determined by the action filter 322 by applying the UI context 325 to the report metadata 327) can be communicated from the server to the client. Alternatively, the client program 310 could incorporate logic to determine valid actions.

The client program 310 can send an indication of an activated action 370 to the server program 320, which has accesses to the business object 380 to perform the activated action on the underlying data 190.

In practice, additional components can be included to implement security, report design, and the like.

### Example 7

### Exemplary User Interface

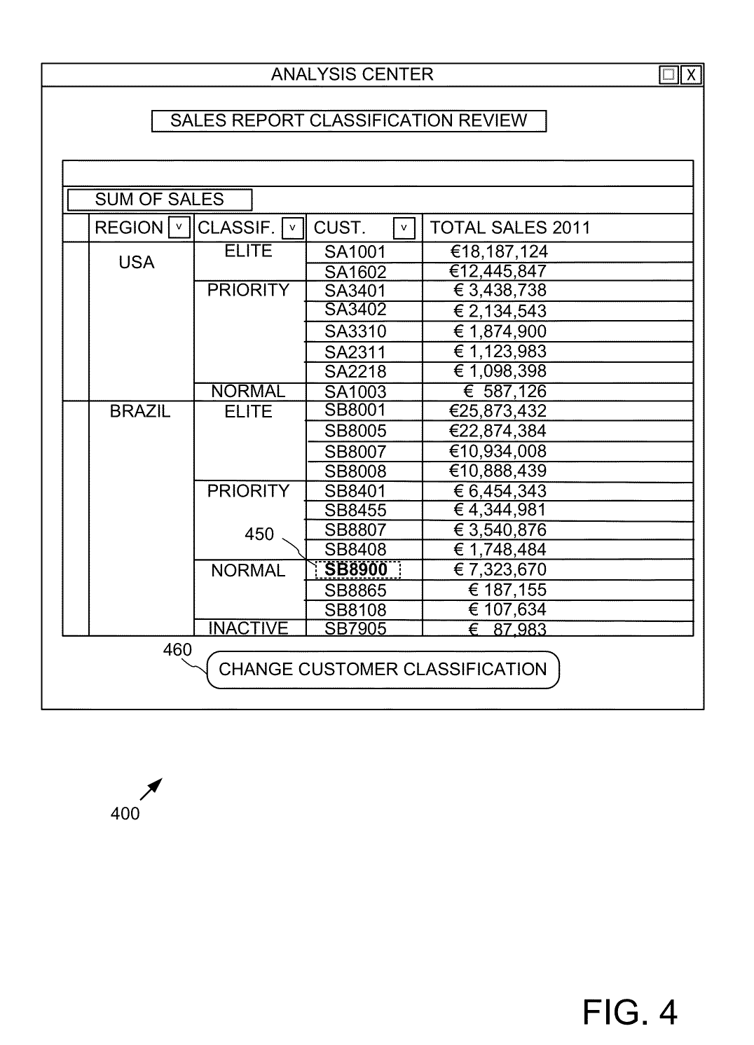

FIG. 4 is a screen shot of an exemplary user interface 400 implementing integration of transactional actions into analytical reports. In the example, the user interface 400 presents an online analytical processing session showing sales according to one or more data sources. In practice, additional dimensions (e.g., a time dimension) can also be displayed.

A customer number 450 has been selected, and a user interface element 460 associated with a valid action (e.g., “change customer classification”) that can be performed on the underlying data (e.g., a customer record associated with the customer number 450) is displayed. Although a graphical pushbutton 460 is displayed, any number of other elements (e.g., link, menu, list box, or the like) can be used.

The user interface element 460 can be activated to perform the action on the underlying data. The user interface 400 can then be updated to reflect that the action has been performed (e.g., by moving the information for customer number 450 into a different classification when displayed).

### Example 8

### Exemplary Method: Server

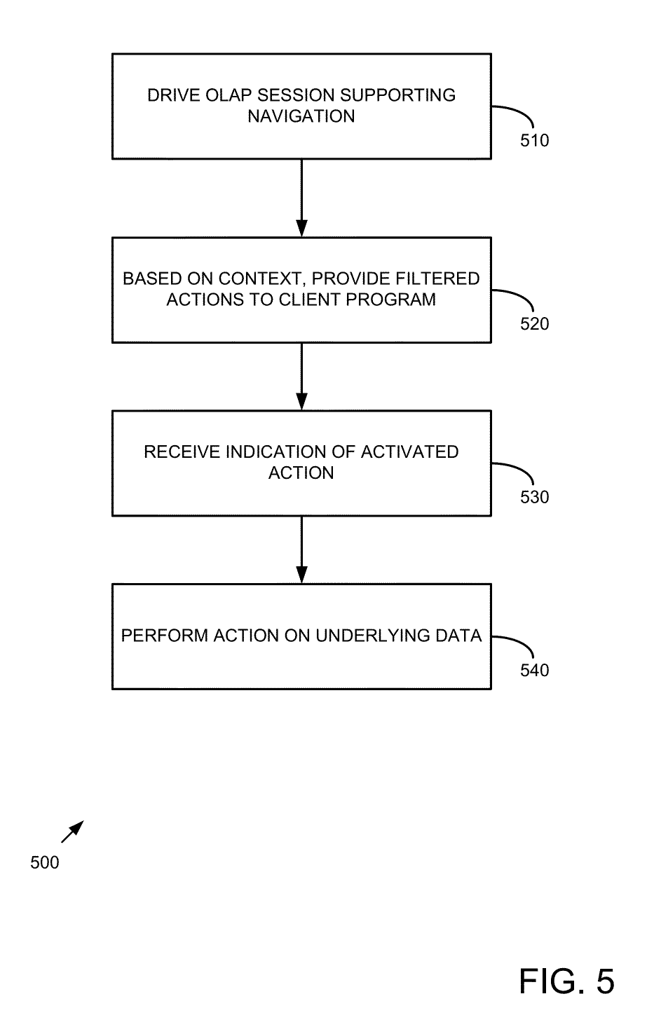

FIG. 5 is a flowchart of an exemplary method 500 implementing integration of transactional actions into analytical reports at a server (e.g., running an analytical report tool) and can be implemented, for example, in the system shown in FIG. 3, the user interface shown in FIG. 4, in conjunction with the method of FIG. 2, or the like.

At 510, the server drives an OLAP session supporting navigation. At 520, based on context, filtered actions (e.g., valid actions) are provided to the client program for display to a user for activation. At 530, an indication of an activated action (e.g., via a user interface element) is received. At 540, the activated action is performed on transactional data underlying the analytical report. The OLAP session can then be updated to reflect that the action has been performed, and the OLAP session can continue. In some cases, it may be helpful to instead navigate to a different user interface.

### Example 9

### Exemplary Method: Client

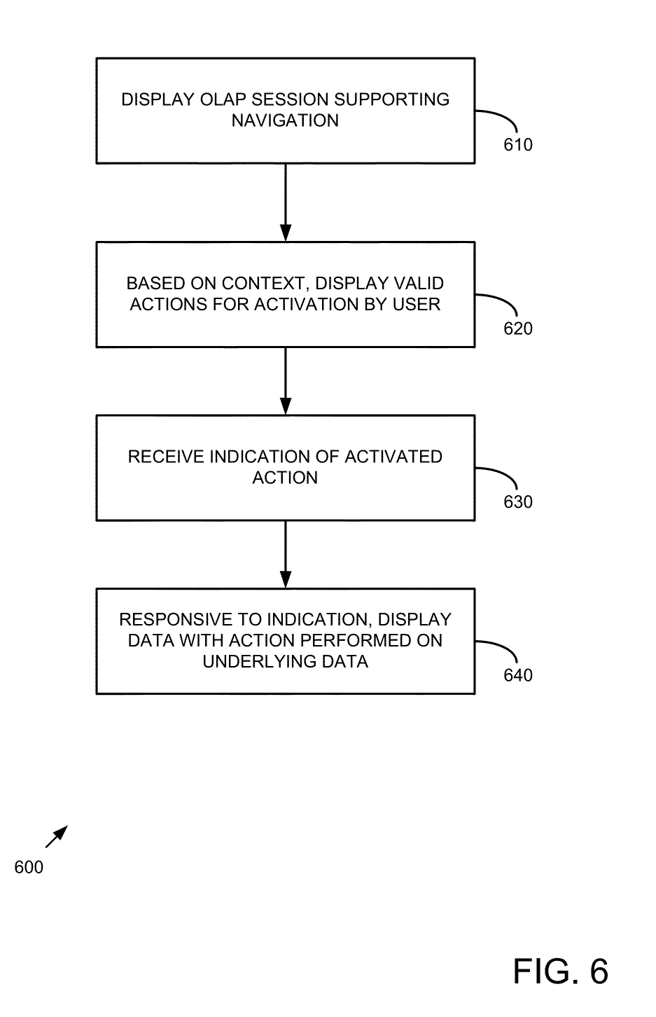

FIG. 6 is a flowchart of an exemplary method 600 implementing integration of transactional actions into analytical reports at a client and can be implemented, for example, in the system shown in FIG. 3, the user interface shown in FIG. 4, in conjunction with the method of FIG. 2, or the like.

At 610, an OLAP session supporting navigation is displayed.

At 620, based on a context of the OLAP session, valid actions for activation by a user are displayed. For example, a user interface element representing an action performable on transactional data underlying the online analytical processing session can be displayed.

At 630, an indication of an activated action is received. For example, an activation by a user of a user interface element associated with the action (e.g., as shown in FIG. 4) can be detected.

At 640, responsive to the indication, the data of the OLAP session is displayed reflecting having performed the action on the underlying data.

### Example 10

### Exemplary Protection of Transactional Data

In any of the examples herein, precautions can be taken to account for the transactional nature of the data underlying the OLAP session. For example, a timestamp associated with the OLAP session can be stored (e.g., reflecting when the report was started, when the data was last known to be current, or the like). Responsive to (e.g., after) an indication that an action is to be performed, but before performing an activated action, it can be verified that the data underlying the analytical processing session has not changed after a time indicated in the timestamp. Such an approach prevents actions from being taken based on stale data without locking the data.

Also, responsive to (e.g., after) an indication that an action is to be performed, but before an activated action is performed, the data underlying the OLAP session (e.g., data that is changed by the action) can be locked. Upon successful completion of the action, the changes can be committed to the database. Such an approach can avoid locking data immediately upon data selection, which is typically undesirable due to performance reasons.

### Example 11

### Exemplary Action Filtering

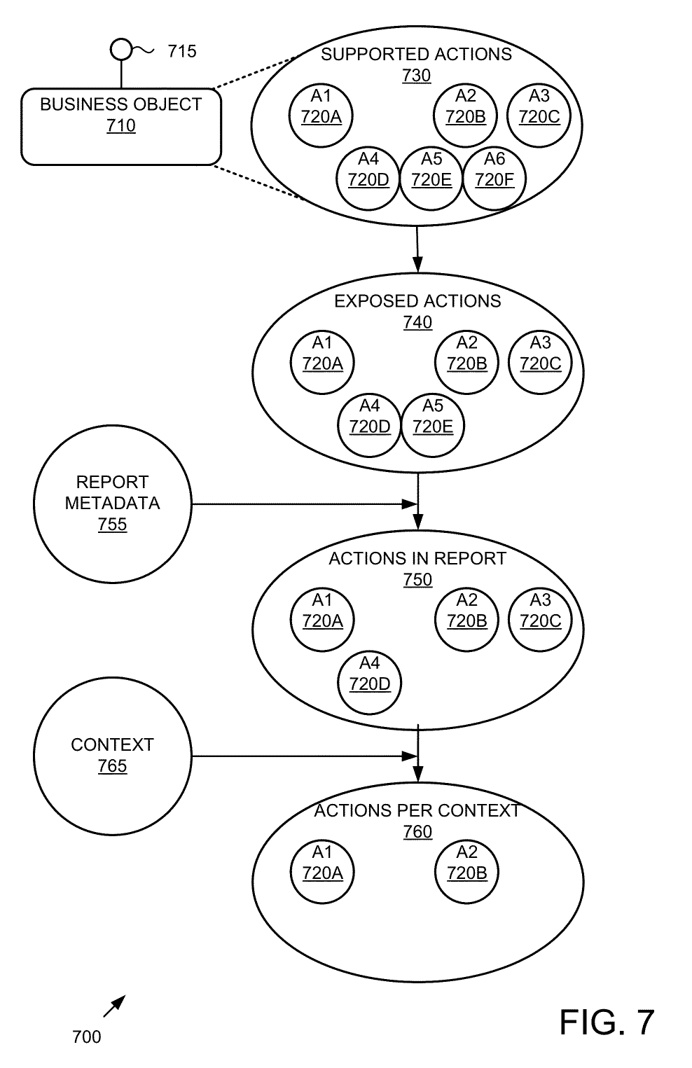

In any of the examples herein, action filtering can be implemented. FIG. 7 is a block diagram showing exemplary action filtering scenario 700. In the example, the business object 710 supports a set 730 of actions 720A-F via its interface 715.

The developer of the system hosting the business object 710 may decide to expose only a subset 740 of actions 720A-E for use by those developing reports for the system. Although such actions may be available by other means, they can thus be restricted for use in analytical reports.

Further filtering of the actions can be accomplished via report metadata 755 for a given report. For example, the report may specify that only a subset 750 of actions 720A-D are available to the given report.

Still further filtering of the actions can be accomplished via a context 765 of the OLAP session. For example, a user interface context can reflect which data (e.g., fields) or data types are currently displayed in the session, which are selected by a user in the session, or both. Based on the context 765, the actions can be filtered down to a valid set 760 of actions 720A-B that can be activated by a user. For example, if a user adds a particular dimension to the OLAP session (e.g., customer), actions valid for a customer can appear. Or, responsive to selection of a particular field (e.g., customer), actions valid for a customer can appear. Metadata associated with the report during report design (e.g., according to the developer's instructions) can be consulted to determine which actions are valid for which dimensions, fields, or the like.

Additional filtering can be performed in light of security (e.g., based on role-based access control) settings. Such security settings can be simplified to reflect that access to the report grants access to whatever actions are indicated in the report metadata, or separate settings can enforce restrictions preventing access to certain actions, even if they would ordinarily be accessible via the report.

### Example 12

### Exemplary User Interface: Acquisition of Parameters

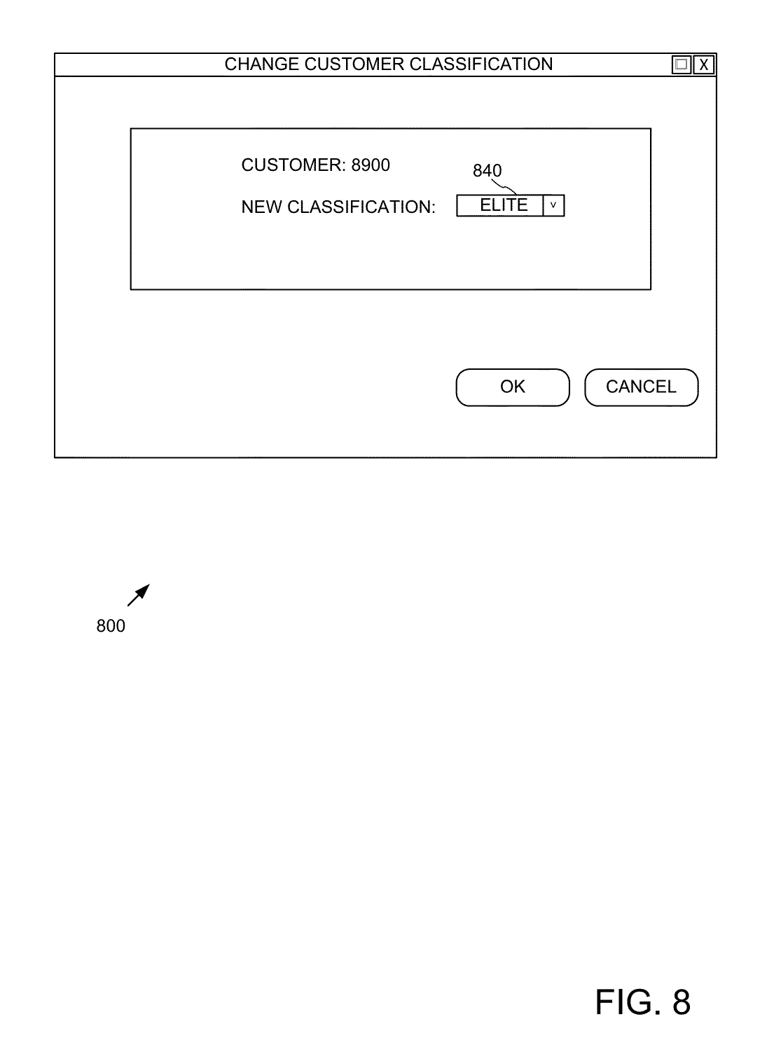

FIG. 8 is a screen shot of an exemplary user interface 800 implementing acquisition of parameters for a transactional action. In the example, a user interface element 840 is displayed by which a user can input a parameter for performing a transactional action. Although a drop down list is shown, any number of other elements are possible (e.g., text box, combo box, radio button, slider, or the like).

The popup user interface 800 can include some logic for checking whether the values specified are of a legal format (e.g., date, numeric, positive value, etc.) to avoid a validation round trip to the server.

### Example 13

### Exemplary Method of Acquiring Parameters: Server

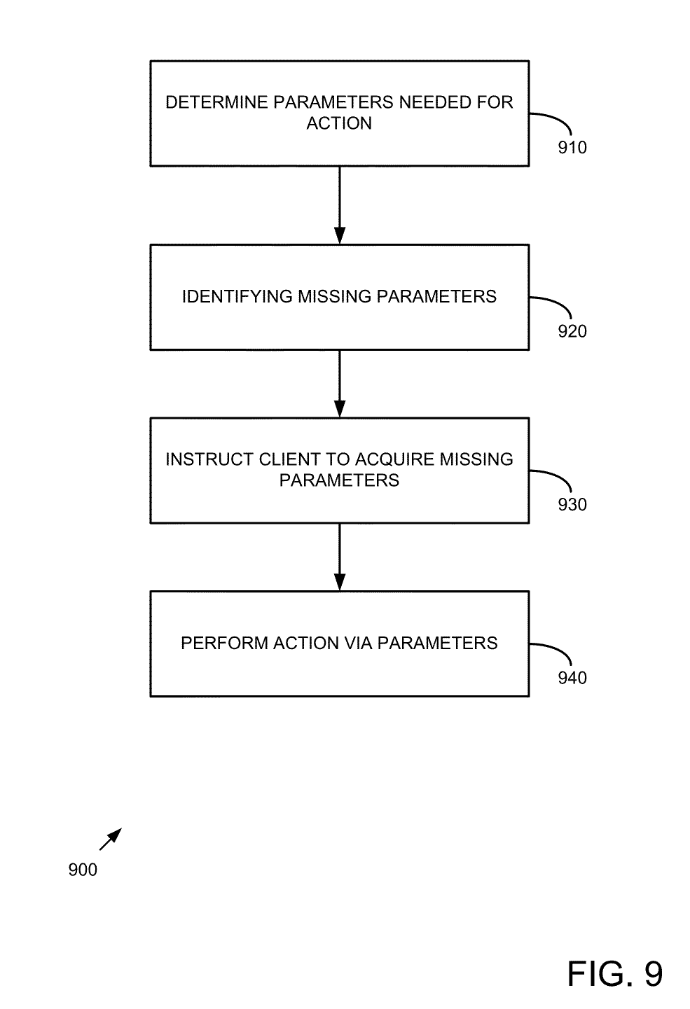

FIG. 9 is a flowchart of an exemplary method 900 implementing acquisition of parameters for a transactional action at a server.

At 910, the parameters needed for an action are determined. For example, for actions performed via a business object, a data model incorporating the business object can be consulted. At 920, missing parameters are identified. If one or more needed parameters are not available, they are considered missing. For example, if an action (e.g., “Change Customer Details”) takes a group of items to be changed and a change value, the group of items may already be specified (e.g., by selection in the user interface). The remaining item (e.g., change value) can be considered missing. Another example is an action (e.g., “Create Target Group”) that takes a group of items and parameters to describe the group. The group of items may already be specified. The parameters to describe can be considered missing.

Responsive to identifying that the parameters are missing, they can be acquired. For example, at 930, the client is instructed to acquire the missing parameters (e.g., via a popup such as that shown in FIG. 8). At 940, the activated action is performed using the one or more acquired parameters. Although the illustrated example shows an example of customer classification, any number of other values can be implemented.

### Example 14

### Exemplary Method of Acquiring Parameters: Client

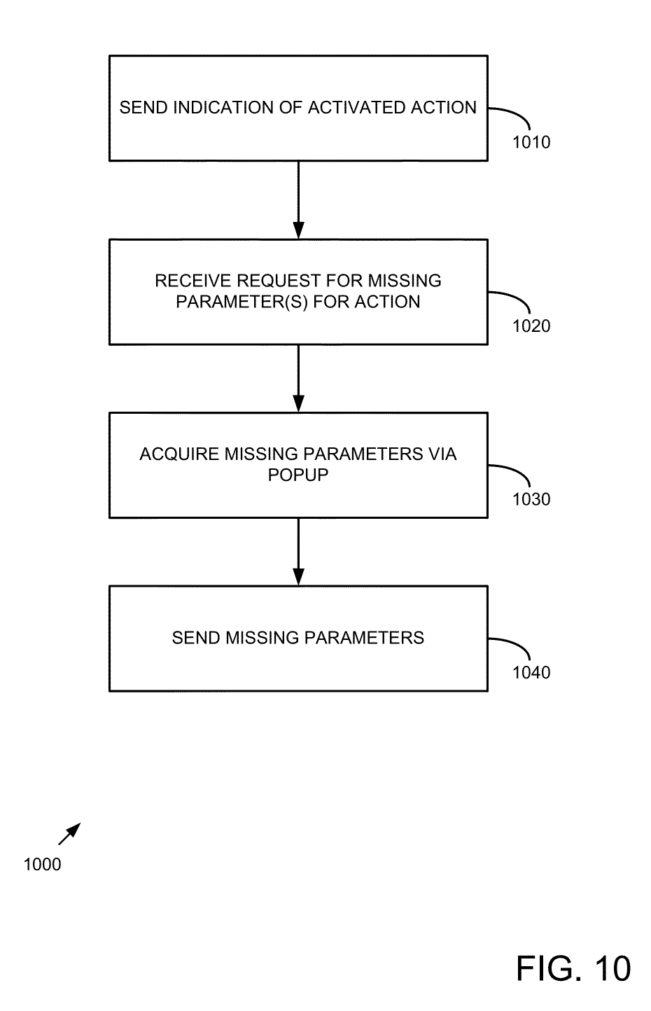

FIG. 10 is a flowchart of an exemplary method 1000 implementing acquisition of parameters for a transactional action at a client. At 1010, an indication of an activated action is sent to the server. At 1020, a request for one or more missing parameters for the action is received in response. At 1030, the missing parameters are acquired via a popup (e.g., such as that shown in FIG. 8). At 1040, the acquired missing parameters are sent to the server for use in performing the activated action.

### Example 15

### Exemplary Data Model

In any of the examples herein, a data model can be used to store metadata for system components and relationships between them. Such data models can already be available as part of an analytical reporting system. The model can be extended to support actions as described herein. For example, in the case of business objects, the data model can specify which actions can be performed, what parameters are needed, and the like. A unified model can be used by which relationships between data can facilitate online analytical processing, including multi-dimensional analytical views, and the like.

### Example 16

### Exemplary Business Objects

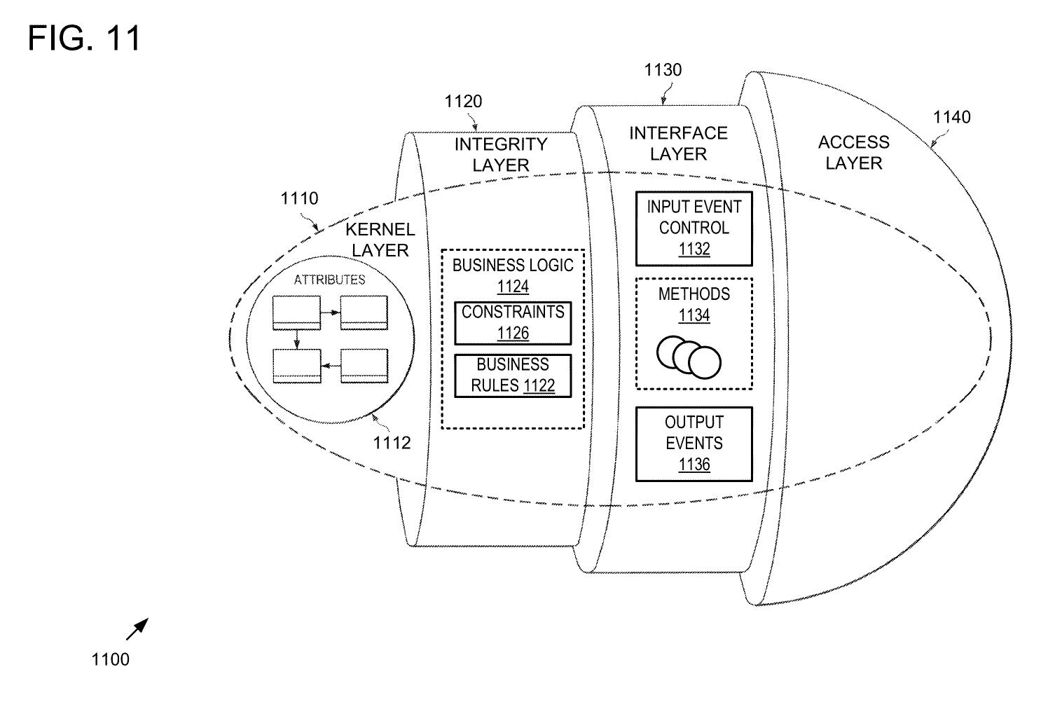

FIG. 11 is a block diagram of an exemplary business object 1100. In any of the examples herein, a business object can take the form of a programmatic object that holds a set of instance variables (e.g., attributes, values, properties, characteristics, or the like). Associations between business objects of different types can be stored in metadata (e.g., as part of a data model), which results in a collection of business objects representing business relationships.

Business objects can support behaviors via invocation of one or more business object programmatic actions (e.g., programmatic methods), through which clients of the business objects can perform operations on the business object (e.g., on the instance variables). Such actions are typically provided via a programmatic interface that supports one or more parameters that perform a task associated with the action (e.g., cancel an order, hire an employee, change a customer classification, create a target group, and the like). An action can trigger complex processes, start a link, or invoke a simple method.

In the example, the business object 1100 can be defined to contain multiple layers. Exemplary layers include a kernel layer 1110, which represents the object's inherent data, comprising attributes 1112 of the defined business object. An integrity layer 1120 can contain the business logic 1124, which can include business rules 1122 for consistent embedding in the system and the constraints 1126 regarding the values and domains that apply. For example, business logic 1124 can comprise statements that define or constrain some aspect of the business, such that they are intended to assert business structure or to control or influence the behavior of the business entity. It may pertain to the facts recorded on data and constrains on changes to the data. The business logic 1124 can thus determine what data may or may not be recorded in the business object 1100.

The interface layer 1130 can supply valid options for accessing the business object 1100 and describe the implementation, structure, and interface of the business object to the outside world (e.g., the analytical report tool described herein). The interface layer 1130 typically contains programmatic methods 1134 (e.g., invocable to perform the actions described herein), input event controls 1132, and output events 1136.

The access layer 1140 can define the technologies that can be used for external access to the business object's data. Possible technologies can include Hypertext Transfer Protocol (HTTP), Java, COM/DCOM/COM+/.NET (e.g., based on the Component Object Model of Microsoft Corporation), CORBA (Common Object Request Broker Architecture), RFC (Remote Function Call), and the like. Additionally, the business object can implement object-oriented technologies such as encapsulation, inheritance, polymorphism, or combinations thereof.

Systems that employ business objects in an intelligent way can offer a rich set of reusability to non-technical users because the business objects can represent easily understandable real-world items such as an order, customer, supplier, invoice, and the like. Similarly, actions on the business objects can reflect real-world tasks (e.g., business processes, etc.) as described here.

### Example 17

### Exemplary Online Analytical Processing

In any of the examples herein, online analytical processing (OLAP) can be used as a tool to explore data sources (e.g., typically data base tables combined by joins, unions, or the like). In practice, online analytical processing involves multi-dimensional analytics, dimensional models, star schemas, snowflake schemas, data cubes, pivot tables, or the like.

An online analytical processing session can be based on an analytical report, which specifies data sources and relationships between such sources for the analytical report. As described herein, an OLAP session can be constructed with reference to a data model that includes at least one business object designated to model data from a data source.

Upon activation of the analytical report, an online analytical processing session begins. The session can then support navigation within the data (e.g., adding or removing certain dimensions, drilling down, slicing and dicing, consolidating data via rollups and aggregation, and the like). Thus, the data model allows ad-hoc navigation throughout the data. In the case of warehoused data such as a data cube, the user can navigate the data throughout the cube. However, traditional analytical reports do not allow modification of the data underlying the displayed data.

Although the data used for online analytical processing is traditionally separated from that used in online transactional processing (e.g., into a data warehouse), it is possible to support online analytical processing that draws from the same or similar data sources as those used for online transactional processing. Thus, although data appears to the user to be warehoused, it can be a virtual warehouse not requiring conventional warehousing techniques. As described herein, business objects can serve the data from data sources to provide the online analytical view as well as a transactional view.

Thus, in any of the examples herein, a data source can take the form of transactional data underlying the online analytical processing session (e.g., the transactional data from which analytical data is drawn, or the same source used for the analytical data).

### Example 18

### Exemplary Underlying Data

In any of the examples herein, underlying data can take the form of data from which the data presented during online analytical processing navigation is derived. Such underlying data is typically the live data on which transactions are performed and is therefore sometimes called “transactional data” (e.g., as that used in online transactional processing).

Underlying data can take the form of any of a variety of data sources, including database tables. In practice, such tables can be represented by business objects, which can represent not only the data and the table, but a description of the model, actions, and the like.

### Example 19

### Exemplary Actions

In any of the examples herein, actions can be programmatic actions performed on the underlying (e.g., transactional) data via a business object. Such actions can include modifying the underlying data (e.g., modifying displayed data, modifying a database table on which the displayed data is based, canceling an order, changing a customer classification, creating a record, editing a record, deleting a record, or the like), adding the data to a list (e.g., creating a target group, adding the data to a target group, or the like), or the like. Actions can also be arbitrarily complex actions (e.g., complete hiring of an employee) that affect multiple underlying database tables. Actions can correspond to (e.g., have the same name as) a programmatic method of a business object that initiates the action.

Because the data underlying an online analytical processing report session is typically transactional data, and programmatic actions can be performed on such data underlying the report session, the programmatic actions herein are sometimes called “transactional actions.”

Performing an activated action can comprise invoking an exposed business object method corresponding to the activated action. As described, a single action can set into motion a complex series of database modifications. Thus, performing the action can comprise initiating the action via invocation of a programmatic method of the business object.

Performing an activated action can comprise invoking a programmatic method on a business object having access to the transactional data underlying the OLAP session. As described herein, such a business object can be part of a data model so that the business object is also consulted during the OLAP session to obtain data displayed during the session. Thus, a business object can support actions specified during an OLAP session (e.g., and navigation during the OLAP session) as well as actions specified during an online transactional processing (OLTP) session (e.g., based on a report template). The business object can thus provide access to the data sources in either scenario while implementing business logic associated with the business object.

As a result of modifying the underlying data, affected displayed data (e.g., during the online analytical processing session) is also updated to reflect that the action has been performed. Thus, any changes to data by the action appear to propagate from the OLAP view to the transactional data and are then ultimately reflected in the OLAP view.

### Example 20

### Exemplary User Interface Context

In any of the examples herein, user interface context can be determined based on actions taken on a user interface. For example, when a user selects a row or cell of data displayed during an online analytical processing session, the type of data selected, the field(s) selected, or a business object associated with the data can be added to the context. Having determined such a context, metadata (e.g., associated with the report on which the session is based) can be consulted to determine which actions are available, and user interface elements for such actions can be displayed for activation by a user.

### Example 21

### Exemplary Report Design

In any of the examples herein, an analytical report design tool (e.g., a web-based tool or the like) can be extended to support actions as described herein. Such a tool can create new report templates from the beginning or modify supplied reports (e.g., to create another, customized report). Such an approach can be attractive to internal (e.g., key user) developers who wish to expose actions to users via a familiar user interface. Report configuration can include specifying which actions are available to users. During design, a developer can specify on which report fields an action is to appear as part of the report configuration. An indication of needed parameters can also be stored as part of the configuration (e.g., based on what parameters a data model indicates is needed for the action).

Tools can be provided that consult a data model to list the exposed actions, from which the developer can choose for availability in the report. For example, during design of the report template, actions performable on a business object (e.g., associated with fields of the report) can be displayed according to permissions associated with the report template. User input from the developer can be accepted indicating which of the actions are to be made available (e.g., are valid) during the online analytical processing session based on the report template. The report configuration can be stored as metadata, which can be used as described herein to achieve action filtering (e.g., filtering based on selected or displayed fields having metadata indicating valid actions). Thus, the metadata originates from an indication of valid actions received during design of the report template.

In practice, a single analytical report can draw from many different types of business objects and leverage the data model, which specifies how the business objects are related. When the report is activated, the data can be drawn from one or more databases via business objects as described herein. Although the data model can be complex, the user's perception of it can be simplified due to reliance on familiar real-world objects associated with the business objects.

### Example 22

### Exemplary Developers

In any of the examples herein, a developer can be any party or entity developing reports for access by users. Developers can include both external developers (e.g., who initially design the system for use and customization by customers) and internal developers (e.g., customer-level developers who customize and/or extend the system for use by internal customers).

### Example 23

### Exemplary Computing Systems

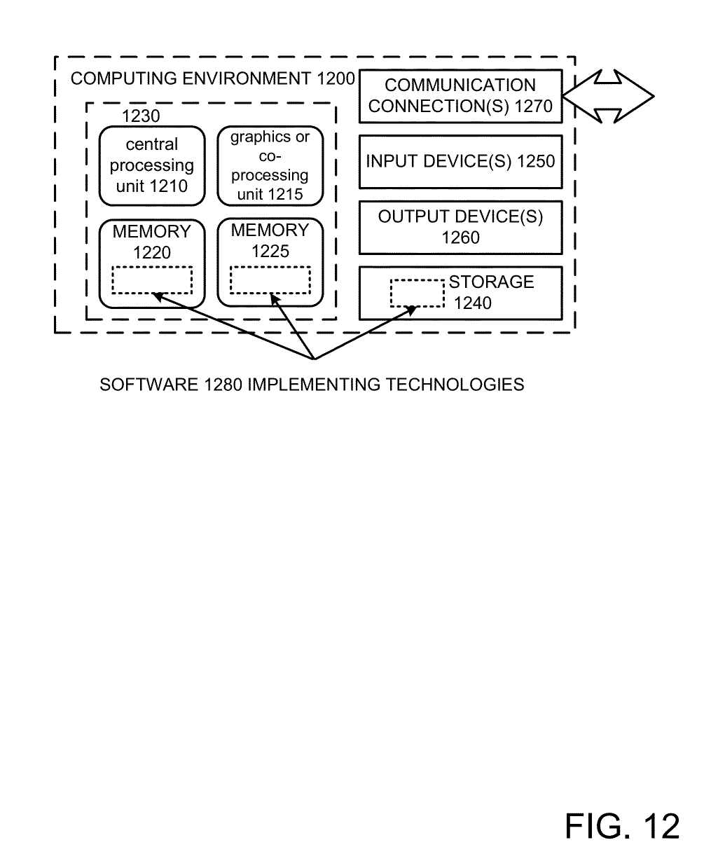

FIG. 12 illustrates a generalized example of a suitable computing system 1200 in which several of the described innovations may be implemented. The computing system 1200 is not intended to suggest any limitation as to scope of use or functionality, as the innovations may be implemented in diverse general-purpose or special-purpose computing systems.

With reference to FIG. 12, the computing system 1200 includes one or more processing units 1210, 1215 and memory 1220, 1225. In FIG. 12, this basic configuration 1230 is included within a dashed line. The processing units 1210, 1215 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power. For example, FIG. 12 shows a central processing unit 1210 as well as a graphics processing unit or co-processing unit 1215. The tangible memory 1220, 1225 may be volatile memory (e.g., registers, cache, RAM), non-volatile memory (e.g., ROM, EEPROM, flash memory, etc.), or some combination of the two, accessible by the processing unit(s). The memory 1220, 1225 stores software 1280 implementing one or more innovations for consumer transaction redundancy filtering, in the form of computer-executable instructions suitable for execution by the processing unit(s).

A computing system may have additional features. For example, the computing system 1200 includes storage 1240, one or more input devices 1250, one or more output devices 1260, and one or more communication connections 1270. An interconnection mechanism (not shown) such as a bus, controller, or network interconnects the components of the computing system 1200. Typically, operating system software (not shown) provides an operating environment for other software executing in the computing system 1200, and coordinates activities of the components of the computing system 1200.

The tangible storage 1240 may be removable or non-removable, and includes magnetic disks, magnetic tapes or cassettes, CD-ROMs, DVDs, or any other medium which can be used to store information in a non-transitory way and which can be accessed within the computing system 1200. The storage 1240 stores instructions for the software 1280 implementing one or more innovations for integrating transactional actions into analytical reports.

The input device(s) 1250 may be a touch input device such as a keyboard, mouse, pen, or trackball, a voice input device, a scanning device, or another device that provides input to the computing system 1200. For video encoding, the input device(s) 1250 may be a camera, video card, TV tuner card, or similar device that accepts video input in analog or digital form, or a CD-ROM or CD-RW that reads video samples into the computing system 1200. The output device(s) 1260 may be a display, printer, speaker, CD-writer, or another device that provides output from the computing system 1200.

The communication connection(s) 1270 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

### Example 24

### Computer-Readable Media

Any of the computer-readable media herein can be non-transitory (e.g., volatile memory such as DRAM or SRAM, nonvolatile memory such as magnetic storage, optical storage, or the like) and/or tangible. Any of the storing actions described herein can be implemented by storing in one or more computer-readable media (e.g., computer-readable storage media or other tangible media). Any of the things (e.g., data created and used during implementation) described as stored can be stored in one or more computer-readable media (e.g., computer-readable storage media or other tangible media). Computer-readable media can be limited to implementations not consisting of a signal.

Any of the methods described herein can be implemented by computer-executable instructions in (e.g., stored on, encoded on, or the like) one or more computer-readable media (e.g., computer-readable storage media or other tangible media) or one or more computer-readable storage devices (e.g., memory, magnetic storage, optical storage, or the like). Such instructions can cause a computing device to perform the method. The technologies described herein can be implemented in a variety of programming languages.

### Alternatives

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the following claims. We therefore claim as our invention all that comes within the scope and spirit of the claims.

We claim:

1. A method implemented at least in part by a computer, the method comprising:
conducting an online analytical processing session supporting navigation;
filtering possible actions to one or more valid actions for selection by a user;
during the online analytical processing session, receiving an indication of an activated one of the valid actions; and
responsive to the indication, performing the activated action on transactional data underlying the online analytical processing session.

2. One or more computer-readable storage devices comprising computer-executable instructions for performing the method of claim 1.

3. The method of claim 1 further comprising:
after performing the activated action, updating the online analytical processing session to reflect that the activated action has been performed.

4. The method of claim 1 wherein:
performing the activated action comprises modifying the transactional data underlying the online analytical processing session.

5. The method of claim 1 further comprising:
identifying that one or more parameters are missing for the activated action; and
responsive to identifying that one or more parameters are missing for the activated action, acquiring the one or more parameters;
wherein performing the activated action comprises using the one or more acquired parameters.

6. The method of claim 1 further comprising:
receiving an indication of a selection of a subset of data displayed during the online analytical processing session;
wherein performing the activated action comprises performing the activated action on the subset of data.

7. The method of claim 6 wherein:
filtering possible actions is based on the selection of a subset of data.

8. The method of claim 1 wherein:
the online analytical processing session is based on a defined report template having associated report template metadata; and
filtering possible actions is based on the report template metadata.

9. The method of claim 8 wherein:
the report template metadata originates from an indication of valid actions received during design of the report template.

10. The method of claim 1 wherein the online analytical processing session is based on a report template, the method further comprising:
during design of the report template, displaying actions performable on a business object according to permissions associated with the report template; and
accepting user input indicating which of the actions are to be made available during the online analytical processing session.

11. The method of claim 1 wherein:
filtering possible actions is based on which fields are currently displayed in the online analytical processing session.

12. The method of claim 1 further comprising:
storing a timestamp associated with the online analytical processing session; and
before performing the activated action, verifying that the transactional data underlying the online analytical processing session has not changed after a time indicated in the timestamp.

13. The method of claim 1 further comprising:
after receiving the indication and before performing the activated action, locking the transactional data underlying the online analytical processing session.

14. The method of claim 1 wherein:
performing the activated action comprises invoking a programmatic method on a business object having access to the transactional data underlying the online analytical processing session.

15. The method of claim 14 wherein:
conducting the online analytical processing session comprises obtaining data displayed during the session from the business object.

16. A method implemented at least in part by a computer, the method comprising:
displaying an online analytical processing session supporting navigation;
based on a context of the online analytical processing session, displaying a user interface element representing an action performable on data underlying the online analytical processing session;
during the online analytical processing session, receiving an activation of the user interface element; and
responsive to receiving the activation of the user interface element, displaying data reflecting having performed the action on the data underlying the online analytical processing session.

17. The method of claim 16 further comprising:
receiving a selection of displayed data;
wherein the user interface element is displayed responsive to receiving the selection of the displayed data, and context is based at least on receiving the selection of the displayed data.

18. The method of claim 16 wherein:
actions displayed as performable on the data underlying the online analytical processing session are limited to actions specified at design time of a report template associated with the online analytical processing session.

19. The method of claim 16 wherein:
the action comprises changing a customer classification for a customer identifier displayed during the online analytical processing session.

20. A system comprising:
one or more processors;
memory;
a user interface context stored in one or more computer-readable storage media, wherein the user interface context indicates which fields of an online analytical processing report are selected;
report metadata stored in one or more computer-readable storage media, wherein the report metadata indicates which actions are to be presented when a given field is selected;
a timestamp stored in one or more computer-readable storage media, wherein the timestamp indicates a time when the report was current; and
an action filter operable to apply the user interface context to the report metadata, resulting in one or more actions performable on data associated with the selected fields.
